(19) United States
(12) Patent Application Publication
(10) Pub. No.: US 2007/0145217 A1
(43) Pub. Date: Jun. 28, 2007

(54) SUPPORTING BRACKET FOR SURVEYING INSTRUMENT

(76) Inventor: Masaru Kimura, Osaka (JP)

Correspondence Address: Angelo J. Bufalino;Vedder Price Kaufman & Kammholz, 222 North LaSalle Street, Chicago, IL, 60601, US

(21) Appl. No.: 11/381,216

(22) Filed: May 2, 2006

(30) Foreign Application Priority Data
Dec. 22, 2005 (JP) 2005-370957

(51) Int. Cl. G09F 7/18

(52) U.S. Cl. 248/230.1

(57) ABSTRACT

A supporting bracket for a surveying instrument capable of simply and securely fitting each type of surveying instrument to a post 6 made of plastic, by use of the post 6 being light and low-priced, having high strength and hardly causing stains, wherein the supporting bracket 5 for supporting the surveying instrument 3 (receiver) with the post 6 includes a clamped portion 8 to which the survey instrument 3 is clamped to be supported, and a fitting portion 9 fitted to the post 6, and the fitting portion 9 can be fitted to an elliptic post, and a fitting interval to the post is adjustable.

### BACKGROUND OF THE INVENTION

1. Field of the Invention

The present invention relates to a supporting bracket for supporting a surveying instrument with a post.

2. Description of the Related Art

When a horizontal or gradient survey is performed, a laser transmitter and receiver are typically used, and the receiver is supported by a post so as to be vertically adjustable (see patent reference 1). Further, a metallic pipe made of aluminum, etc., is employed as the post, the post being formed in a cross-section rectanglar shape.

Japanese Published unexamined Patent Application No. 2003-121149

Though conventional posts have been lightened by use of aluminum, etc., they have still been heavy. Further, stains such as rust caused by long-term use of a post made of aluminum, etc., make graduations attached to a surface of the post illegible.

### SUMMARY OF THE INVENTION

From such a viewpoint, it has been conceived to make a circular or elliptic post, which has a light weight and high strength and hardly causes stains owing to long-term use, of which manufacturing is easily performed and which can be provided at a low price, with use of plastic. However, it is impossible to securely and strongly fit each type of surveying instrument of various types on the market to such a post made of plastic. Thereupon, it is an object of the present invention to provide a supporting bracket capable of simply and securely fitting each type of surveying instrument to the post made of plastic, the post being light and low-priced, having high strength and hardly causing stains.

In order to accomplish the above object, a supporting bracket for supporting a surveying instrument with a post according to the present invention has a clamped portion to which the surveying instrument is clamped and attached and a fitting portion to be fitted to the post, the fitting portion being capable of adjusting a fitting interval to the post.

When each type of surveying instrument is supported by a post, the surveying instrument on the market is attached to the post by clamping it at the clamped portion of the supporting bracket and then the fitting portion of the supporting bracket is supported by the post. At this time, the fitting portion of the supporting bracket becomes capable of adjusting the fitting interval so that the supporting bracket can be fitted to the post made of plastic via the fitting portion, and therefore each type of surveying instrument can be fitted to the post to be vertically adjustable via the supporting bracket. The post made of plastic is light and low-priced, has high strength and hardly causes stains on the post, and therefore it is useful for surveying.

In an embodiment of the present invention, the fitting portion is comprised of a pair of a first clamping member and a second clamping member facing each other, the first and second clamping members are supported on a base table so as to be relatively displaceable. According to this constitution, adjustment of the fitting interval of the fitting portion can be easily performed. Thus, fitting each type of surveying instrument to the post and vertical adjustment of the surveying instrument become easy.

In another embodiment of the present invention, the first clamping member includes a first clamping piece supported to be movable along the base table and a claw portion slidably supported by the first clamping piece and capable of engaging with or disengaging from a plurality of steps of groove portions formed at the base table, and the second clamping member includes a second clamping piece movably supported by a screw body threaded into a part of the base table. According to this constitution, the first clamping piece is moved to a predetermined position to the base table while engaging or disengaging the claw portion with or from the groove portions of the base table, and the second clamping piece is movably adjusted to the first clamping piece via the screw body in this state. Therefore, adjustment of the fitting interval between the first and second clamping pieces can be securely performed, the supporting bracket can be simply and securely fitted to the post via these clamping pieces, and the vertical adjustment of the supporting bracket, or the surveying instrument, can be easily performed.

In another embodiment of the present invention, each facing surface of the first clamping piece of the first clamping member and the second clamping piece of the second clamping member is formed in a substantially V-shape. According to this constitution, even if the post is circular or elliptic, the supporting bracket can be securely and strongly fitted to a post via the first and second clamping members owing to the substantially V-shaped facing surfaces of the clamping pieces.

Further, in another embodiment of the present invention, it is possible to read graduations attached to the post fitted to the fitting portion, through a window formed in the clamped portion to which the surveying instrument is clamped. According to this constitution, though the surveying instrument is supported by the post via the supporting bracket, it is possible to confirm the graduations of the post, a height position of the surveying instrument fixed to the post from a soil level, etc., through the window of the clamped portion, and therefore it is convenient to perform a horizontal or gradient survey, etc.

### BRIEF DESCRIPTION OF THE DRAWINGS

FIG. 1 is a perspective view showing a state where a horizontal or gradient survey, etc., is performed with a laser transmitter and receiver;

FIG. 2 is a front view showing the enlarged supporting bracket;

FIG. 3 is a rear view of the same;

FIG. 4 is a plan view of the same;

FIG. 5 is a bottom view of the same;

FIG. 6 is a left side view of the same;

FIG. 7 is a right side view of the same;

FIG. 8 is a perspective view showing the whole supporting bracket;

FIG. 9 is a front view showing an example of the receiver supported by a post via the supporting bracket;

FIG. 10 is a perspective view showing a state where the receiver is supported by the post via the supporting bracket;

FIG. 11 is a front view showing another example of a receiver supported by the post via the supporting bracket; and

FIG. 12 is a perspective view showing a state where the receiver is supported by the post via the supporting bracket.

### DETAILED DESCRIPTION

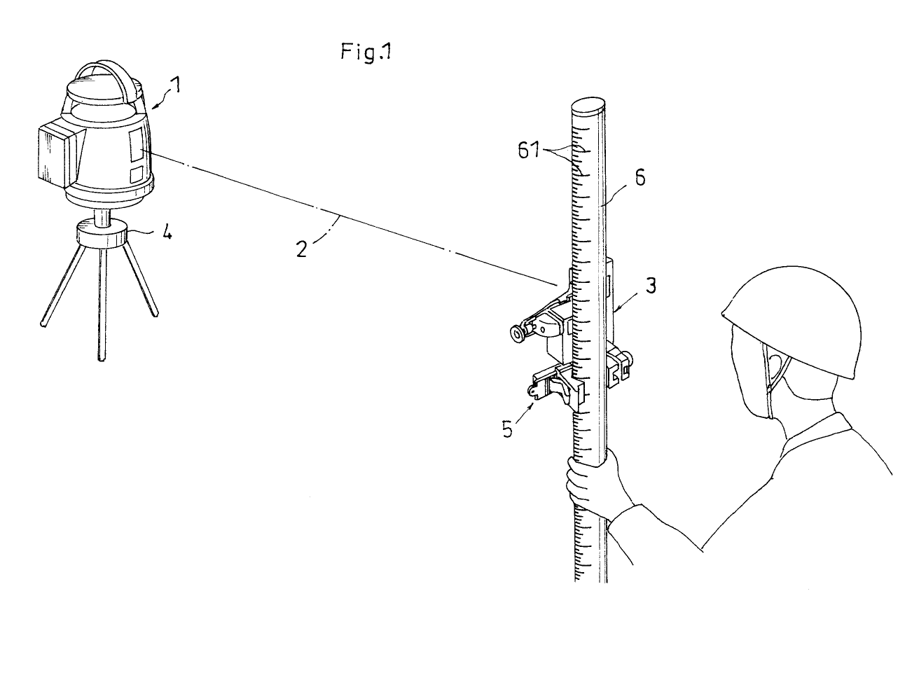

A supporting bracket for a surveying instrument according to the present invention will be explained below referring to the accompanying drawings. FIG. 1 is a perspective view showing a state where a horizontal or gradient survey is performed. In this figure, a laser transmitter 1 outputting a laser beam 2 and a receiver 3 as the surveying instrument receiving the laser beam 2 are used, the receiver 3 receives the laser beam 2 emitted from the transmitter 1 so that the horizontal or gradient survey is performed. The transmitter 1 is supported on a tripod 4, and the receiver 3 is supported by a post 6 via a supporting bracket 5.

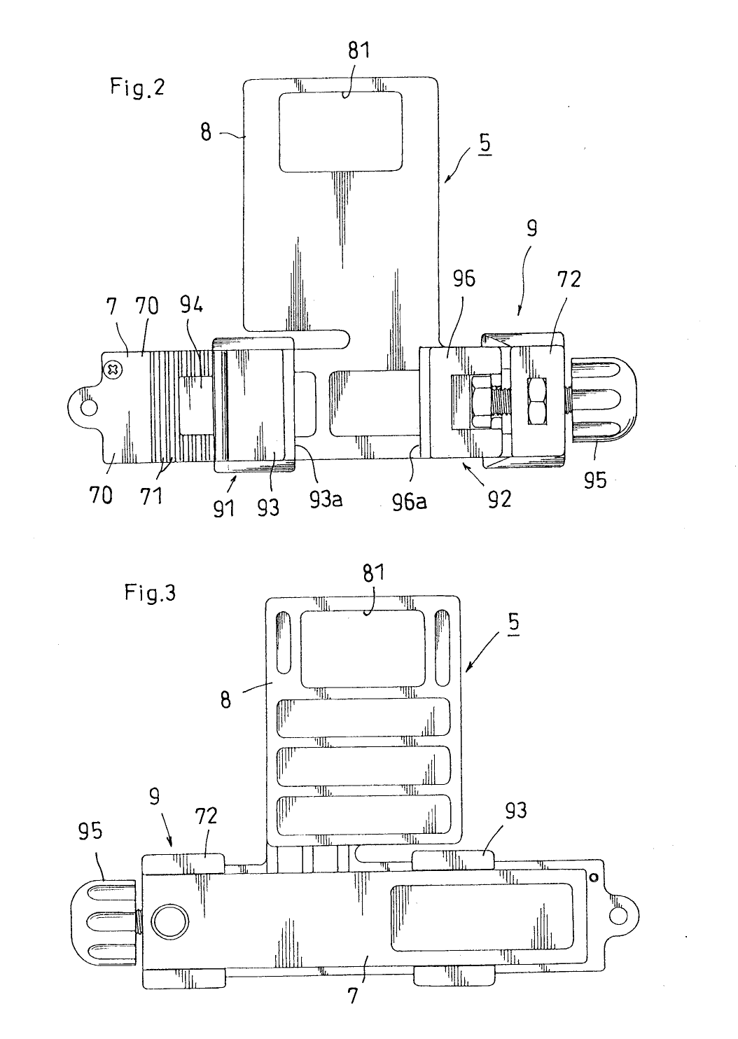

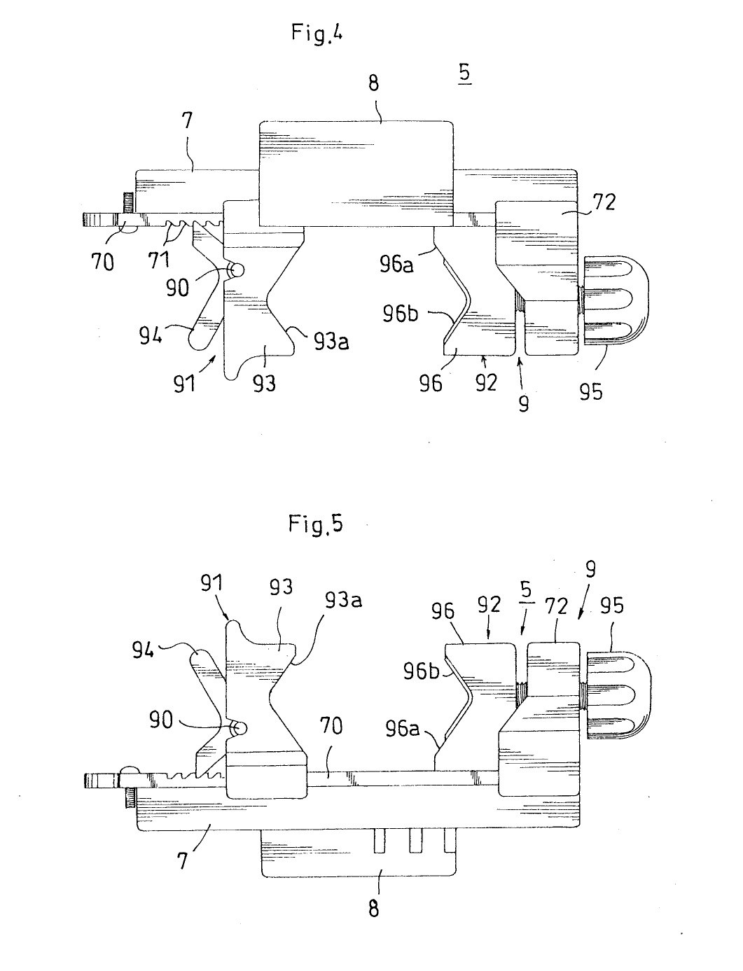

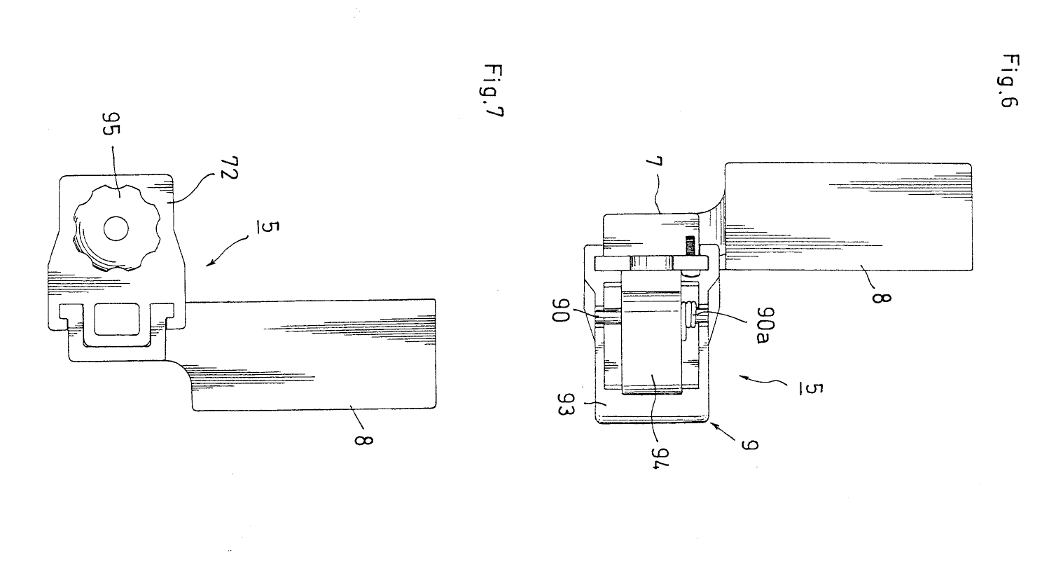

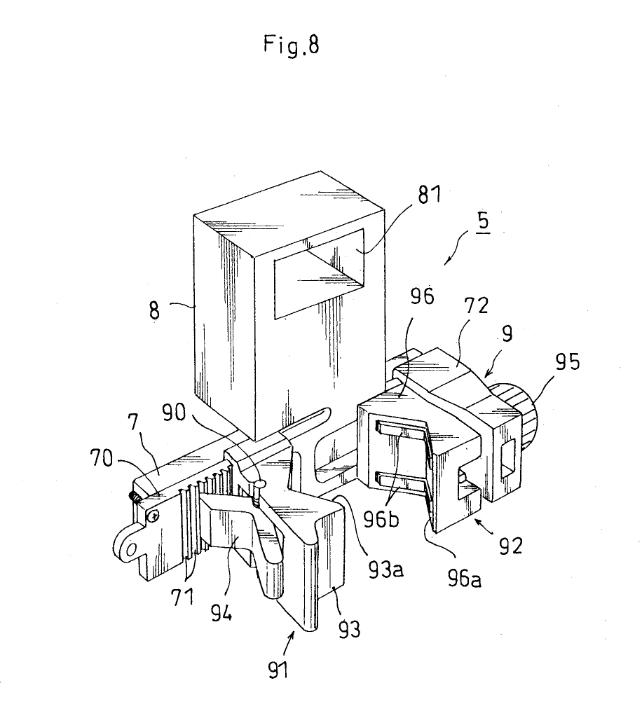

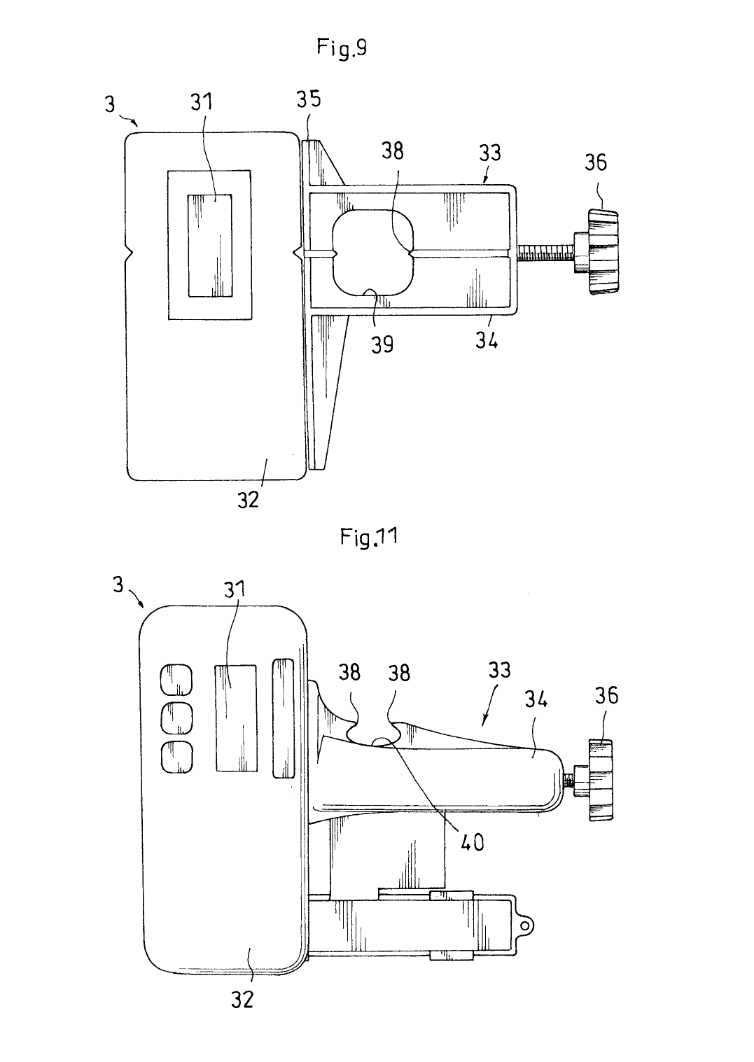

FIG. 2 is a front view showing the enlarged supporting bracket 5 according to the present invention, FIG. 3 is a rear view of the same, FIG. 4 is a plan view of the same, FIG. 5 is a bottom view of the same, FIG. 6 is a left side view of the same, FIG. 7 is a right side view of the same and FIG. 8 is a perspective view showing the whole supporting bracket 5. The supporting bracket 5 shown in FIG. 8 includes: a base table 7 extended in a lateral direction; a cube-shaped clamped portion 8 which is integrally formed on an upper portion of the base table 7 and to which the receiver 3 is clamped and attached; and a fitting portion 9 provided on a rear side of the base table 7 for fitting the whole supporting bracket 5 to the post 6.

The fitting portion 9 is comprised of a pair of a first and second clamping members 91 and 92 facing each other, the first and second clamping members 91 and 92 are respectively supported on the base table 7 so as to be relatively displaceable.

Further, the first clamping member 91 of the fitting portion 9 includes: a first clamping piece 93 supported on a rail 70 formed on an upper lower portion of the base table 7 so as to be movable in the lateral direction; and a claw portion 94 slidably supported by the first clamping piece 93 via a vertical shaft 90 and capable of engaging with or disengaging from a plurality of steps of groove portions 71 formed at the base table 7, the claw portion 94 is always urged in a direction of engaging with the groove portions 71 by a coil spring 90a (see FIG. 6). On the other hand, the second clamping member 92 includes a second clamping piece 96 supported to be relatively displaceable to the first clamping member 91 by a screw body 95 threaded into a projection portion 72 projected orthogonally to a negative side of the base table 7. Further, facing surfaces 93a and 96a of the first and second clamping pieces 93 and 96 of the first and second clamping members 91 and 92 are respectively recessed in a substantially V-shape, a cushion member 96b for anti-slip is provided on the facing surface 96a of the second clamping piece 96.

Furthermore, a rectanglar-shaped window 81 is formed in the clamped portion 8 of the supporting bracket 5, and it is possible to read graduations 61 attached to the post 6, on which the fitting portion 9 is supported, through the window 81.

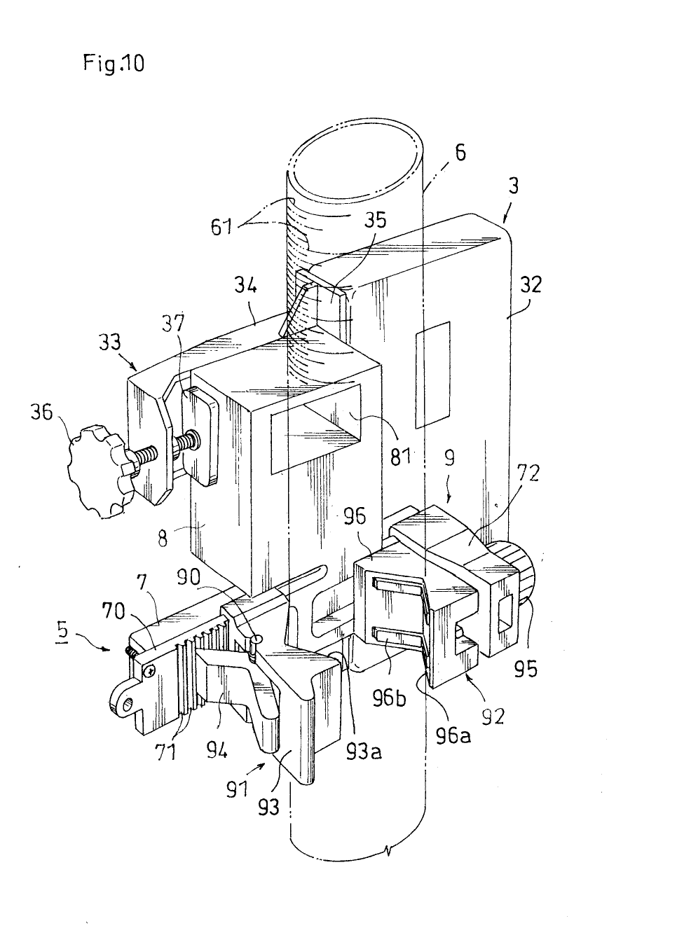

FIG. 9 is a front view showing an example of the receiver 3 supported by the post 6 via the supporting bracket 5, the receiver 3 includes: a photodetector main body 32 that a light receiving surface 31 receiving the laser beam 2 emitted from the transmitter 1 is formed on a front surface of the receiver 3; and a clamping portion 33 attached to the clamped portion 8 of the supporting bracket 5 integrally attached to the photodetector main body 32. The clamping portion 33 includes a substrate 34 extended in the lateral direction. A receiving portion 35 brought into contact with a negative side surface of the clamped portion 8 and a press-contact portion 37 (see FIG. 10) provided at an opposite side to the receiving portion 35 of the clamping portion 33 via a screw body 36 so as to be movement-adjustable and brought into press contact with another surface of the clamped portion 8 are provided at the rear of the substrate 34. Further, a basic point 38 is formed in the substrate 34, the basic point serving as the reference in reading the graduations 61 of the post 6 when the light receiving surface 31 of the receiver 3 receives the laser beam 2 emitted from the transmitter 1 so that a horizontal position is detected. In the embodiment shown in FIG. 9, a rectangular-shaped opening portion 39 is formed in the substrate 34, projection portions projected inward are provided at end edges of both sides of the opening portion 39 respectively, and the projection portions serve as the basic point 38.

FIG. 10 is a perspective view showing a state where the receiver 3 is supported by the post 6 via the supporting bracket 5. As shown in FIG. 10, the receiving portion 35 of the clamping portion 33 provided on the receiver 3 is brought into contact with the negative side surface of the clamped portion 8 of the supporting bracket 5, and the press-contact portion 37 of the clamping portion 33 is pressed against another side surface of the clamped portion 8 while being moved by operation of the screw body 36, the receiver 3 is thus fitted to the clamped portion 8 of the supporting bracket 5. At this time, the opening portion 39 formed in the substrate 34 of the receiver 3 is made to face the window 81 formed in the clamped portion 8 of the supporting bracket 5. Thus, it becomes possible to confirm the graduations 61 attached to the post 6, a height position of the receiver 3 fixed to the post 6 from a soil level, etc., through the opening portion 39 formed in the substrate 34 of the receiver 3 side and the window 81 of the clamped portion 8 provided on the supporting bracket 5, though the receiver 3 is supported by the post 6 via the supporting bracket 5. And accordingly, it becomes convenient to perform a horizontal or gradient survey.

After the receiver 3 is thus fitted to the clamped portion 8 of the supporting bracket 5, the fitting portion 9 of the supporting bracket 5 is supported on the post 6. Concretely, the first clamping piece 93 provided at the first clamping portion 91 of the fitting portion 9 is moved in the lateral direction of the base table 7 in accordance with the size of the post 6 to which the supporting bracket 5 is fitted while engaging or disengaging the claw portion 94 with or from the groove portions 71 of the base table 7. At the same time, the second clamping piece 96 of the second clamping portion 92 facing the first clamping piece 93 is moved in a direction approaching the first clamping piece 93 by operation of the screw body 95, the post 6 is clamped by the first and second clamping pieces 93 and 96, and the receiver 3 is supported by the post 6 via the supporting bracket 5. The first clamping piece 93 is thus moved to a predetermined position to the base table 7 while engaging or disengaging the claw portion 94 with or from the groove portions 71 of the base table 7, and the second clamping piece 96 is movably adjusted so as to approach the first clamping piece 93 via the screw body 95 in this state. Therefore, adjustment of the fitting interval between the first and second clamping pieces 93 and 96 can be securely and accurately performed, the supporting bracket 5 can be simply and securely fitted to the post 6 via these clamping pieces 93 and 96, and vertical adjustment of the supporting bracket 5, or the receiver 3, can be easily performed.

In an embodiment shown in FIG. 10, across-section elliptic post made of plastic is employed as the post 6, both side portions of a lateral axis direction of the ellipse are clamped by the first and second clamping pieces 93 and 96. Whichever the post 6 is elliptic or circular as described above, the supporting bracket 5 can be securely and strongly fitted to the post 6 because these clamping pieces 93 and 96 are respectively formed in a cross-section V-shape. In a case that the elliptic post 6 is employed, rotation of the receiver 3 around the post 6 is avoidable, when the receiver 3 is indirectly fitted to the post 6 via the supporting bracket 5 fitted to the post 6 via the clamping pieces 93 and 96. Moreover, the cushion member 96b for anti-slip is provided on the facing surface 96a of the second clamping piece 96 so that the supporting bracket 5 can be securely and strongly fitted to the post 6. Furthermore, when the supporting bracket 5 as described above is used, it is possible to employ the post made of plastic as the post 6. The post 6 made of plastic is light and low-priced, has high strength, hardly causes stains, and thereby being extremely useful for surveying. Further, the post 6 is formed in such a way that a plurality of pestle bodies having a predetermined length, of which diameters are different from each other, are connected to be telescopic, which is not shown in the Figure, and the length of the post 6 can be adjusted in accordance with a surveying condition, etc.

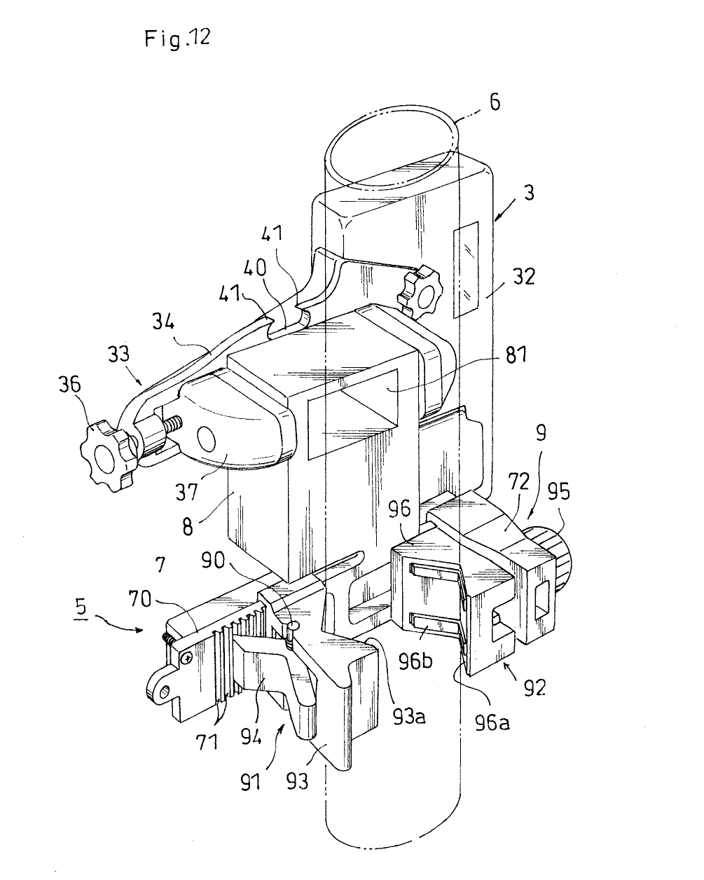

FIG. 11 is a front view showing another example of the receiver 3 supported by the post 6 via the supporting bracket 5, FIG. 12 is a perspective view showing a state where the receiver 3 is supported by the post 6 via the supporting bracket 5. A basic point, which serves as the reference in reading the graduations 61 of the post 6, regarding the receiver 3 shown in this embodiment differs from the basic point 38 regarding the receiver 3 shown in FIG. 9. That is, as shown in FIG. 11, an elliptic opening portion 40, of which the upper portion is opened, is formed at an upper portion of the substrate 34 to which a beam receiver main body 32 is fitted, and projection portions serve as the basic point 38, the projection portions inwardly projecting which are respectively formed on the end edges on both sides of the upper portion thereof.

In this embodiment, similarly to the embodiment shown in FIG. 10, the receiver 3 can be simply and securely fitted to the post 6 made of plastic via the supporting bracket 5, the post 6 being light and low-priced, having high strength and hardly causing stains.

According to a supporting bracket of the present invention, each type of surveying instrument can be simply and securely fitted to a post made of plastic, the post being light and low-priced, having high strength and hardly causing stains.

What is claimed is:

1. A supporting bracket for a surveying instrument for supporting the surveying instrument with a post, having a clamped portion to which the surveying instrument is clamped and attached and a fitting portion to be fitted to the post, the fitting portion being capable of adjusting a fitting interval to the post.

2. The supporting bracket for the surveying instrument according to claim 1, wherein
the fitting portion is comprised of a pair of a first clamping member and a second clamping member facing each other, and
the first and second clamping members are respectively supported on a base table so as to be relatively displaceable.

3. The supporting bracket for the surveying instrument according to claim 2, wherein
the first clamping member comprising:
a first clamping piece supported to be movable along the base table; and
a claw portion slidably supported by the first clamping piece and capable of engaging with or disengaging from a plurality of steps of groove portions formed at the base table, and
the second clamping member comprises a second clamping piece movably supported by a screw body threaded into a part of the base table.

4. The supporting bracket for the surveying instrument according to claim 2 or 3, wherein each facing surface of the first clamping piece of the first clamping member and the second clamping piece of the second clamping member is formed in a substantially V-shape.

5. The supporting bracket for the surveying instrument according to any one of claims 1 to 4, wherein it is possible to read graduations attached to the post fitted to the fitting portion, through a window formed in the clamped portion to which the surveying instrument is clamped.
